(19) United States
(12) Patent Application Publication
(10) Pub. No.: US 2012/0222950 A1
(43) Pub. Date: Sep. 6, 2012

(54) Sealing device for a coking plant charged with a coal cake

(76) Inventors: Norbert Peter, Schoeneck (FR); Ralph Eiden, Lebach (DE); Joachim Berger, Bous (DE)

(21) Appl. No.: 13/385,678

(22) Filed: Mar. 1, 2012

Related U.S. Application Data
(63) Continuation of application No. PCT/DE2010/001064, filed on Mar. 9, 2010.

(30) Foreign Application Priority Data
Sep. 4, 2009 (DE) 10 2009 040 263.2

(51) Int. Cl. F16J 15/16; C10B 29/06

(52) U.S. Cl. 202/269; 277/345

(57) ABSTRACT

Disclosed is a device for sealing an oven chamber of a coking plant, wherein a sealing frame can be placed against an inlet opening of the oven chamber during charging with a coal cake, from which, on oppositely disposed legs, sealing flaps protrude, which can be swiveled inward by the coal cake, the free end edges of the flaps grazing the coal cake.

This is a Continuation application of PCT/DE2010/001064 Filed Sep. 3, 2010.

### BACKGROUND OF THE INVENTION

The invention relates to a device for sealing an oven chamber of a coking plant.

As known, coking plants comprise several adjacently disposed oven chambers into which a stamped coal block referred to as coal cake is inserted from one end, and out of which coke produced from the coal cake in the oven chamber is ejected at the other end. When the oven chamber is charged, the rectangular coal cake stands on edge on a transporting plate, the so-called setting base, which can be moved into the oven chamber. Once the coal cake has been loaded, the setting base can be withdrawn from the oven chamber and used once more in the production of a stamped coal cake and charging of an oven chamber.

At temperatures of over 1000° C. that prevail in oven chambers, the coal is degassed as soon as the coal cake is loaded into the oven chamber. So-called filling gasses form.

To minimize gas emissions into the environment, a vacuum is applied to oven chambers directly adjacent to the oven chamber that has just been charged, and filling gasses produced in the charged chamber are led away with the aid of a transfer pipe into the adjacent oven chambers and, from there, into a crude gas line.

### SUMMARY OF THE INVENTION

The objective of the invention is to further reduce emissions from coking plants.

The device according to the invention, which achieves this objective, is characterized by a frame which can be placed against the inlet opening of the oven chamber while the oven chamber is charged with a coal cake, from which, on oppositely disposed legs, sealing flaps protrude which can be swiveled inward by the coal cake, the free end edges of which graze the coal cake.

Due to the sealing of the inlet opening of the oven chamber according to the invention, filling gasses are prevented from passing to the outside through the gap between the opening and the coal cake when the coal cake is loaded into the oven chamber due to the rapid displacement of the gas volume in the oven chamber.

The sealing flaps advantageously extend downward to a setting base or transporting plate, which pushes the coal cake into the oven chamber.

The sealing frame is preferably formed as a closed frame, thereby enclosing the entire arrangement of coal cake and transporting plate.

In an advantageous embodiment of the invention, the sealing flaps are multipart, comprising flap sections that can swivel independently of one another. It is therefore possible to compensate for unevenness in the coal cake at the side walls and prevent the formation of larger exit gaps between the sealing flaps and the coal cake.

A further sealing flap, which can swivel about a horizontal axis, can be provided at the upper horizontal frame leg, the free end edge of which rests against the top side of the coal cake.

In a further advantageous embodiment of the invention, the sealing flaps can swivel in the direction of motion of the coal cake and opposite to the direction of motion of the coal cake. Thus, if the coal cake should break during loading, it can be easily withdrawn.

Advantageously, the sealing flaps can be swiveled in at least one direction against a preferably elastic restoring force which holds the sealing flaps in a starting position in which they extend parallel to the frame plane.

In one embodiment of the invention, horizontal rails protrude from the vertical frame legs, by way of which the frame can be moved in the direction of the coal cake in a guide. The guide can be transported together with the loading device, and the frame can therefore be moved from door opening to door opening.

In a further advantageous embodiment of the invention, the frame can be placed against vertical anchoring stands which are disposed on either side of the inlet openings and stabilize the coking plant.

The invention is described in greater detail in the following with reference to an exemplary embodiment and the attached drawings which relate to this exemplary embodiment.

### BRIEF DESCRIPTION OF THE DRAWINGS

FIG. 1 shows a coking plant comprising a sealing device according to the invention,

FIG. 2 is a partial depiction of a sealing frame of the sealing device according to the invention,

FIG. 3 is a complete depiction of the sealing frame of FIG. 2,

FIG. 4 shows the sealing frame of FIG. 3 in a side view,

FIG. 5 shows the sealing frame of FIG. 3 in a front view, and

FIG. 6 shows the sealing frame of FIG. 3 in a top view.

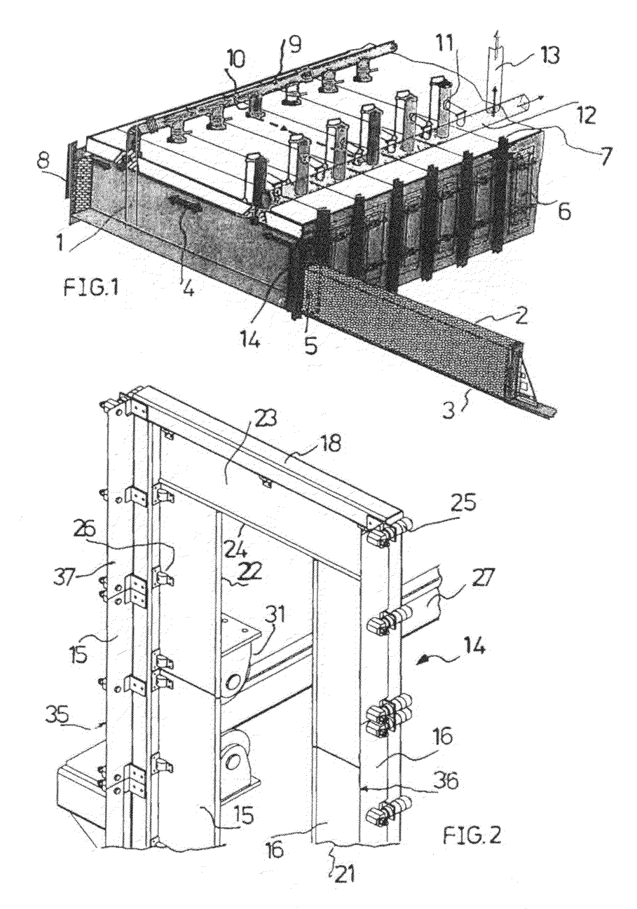

### DETAILED DESCRIPTION OF THE PREFERRED EMBODIMENTS

A coking plant comprises adjacently disposed oven chambers 1 for receiving one coal cake 2 each. When the oven chambers 1 are charged, the rectangular coal cake 2 stands freely on edge on an elongate transporting plate 3, which is also referred to as a setting base, which can be moved as indicated by the double arrow 4.

An opening 5 of the oven chambers 1, through which the coal cake 2 is loaded into the oven chambers 1, can be closed using a removable door 6. Vertical anchoring rods 7 connected to the oven masonry are disposed between the doors 6 of the individual oven chambers 1 and stabilize the coking plant.

Coke produced from the coal cake 2 is ejected out of the oven chamber 1 through an opening 8 which, as with the opening 5, is closed during coking, at the end of the oven chamber 1 opposite the opening 5.

The oven chambers 1 can be connected to one another by way of a transfer pipe 9, from which connecting pieces 10 comprising opening flaps branch off. Furthermore, an ascending pipe 11 is connected to each of the oven chambers 1, which is connected to a collecting main 12, and a crude gas line 13, which is connected to the collecting main 12.

A sealing frame 14, which is described in greater detail with reference to the following figures, can be disposed at the openings 8, which can be moved from oven chamber to oven chamber together with a charging device which loads a coal cake 2 into the particular oven chambers.

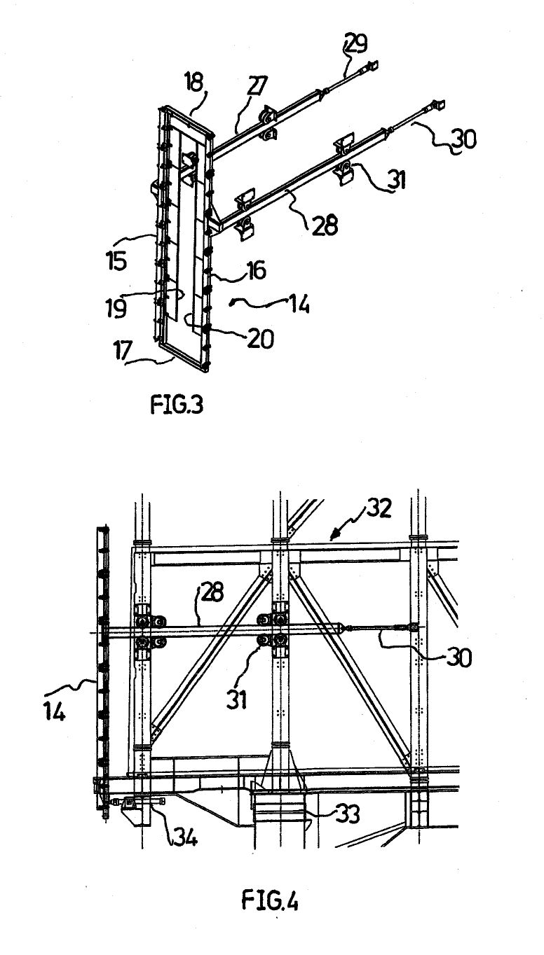

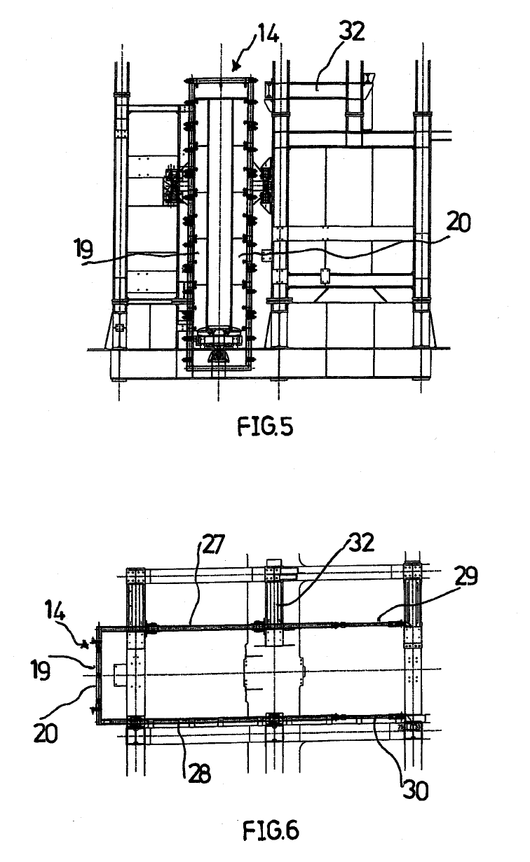

As shown in the following figures, the sealing frame 14 is designed as a closed frame in the exemplary embodiment shown, and comprises a lower horizontal leg 17 (FIG. 3) and an upper horizontal leg 18 next to vertical legs 15 and 16. Sealing flaps 19 and 20 extend inward from the vertical legs 15, 16, respectively. Each of the sealing flaps 19, 20 is multipart, comprising flap sections 21, which directly adjoin one another at the longitudinal ends thereof. The sealing flaps extend downward to the conveyance or setting base 3. Wear-resistant edge reinforcements 22 are provided at the free end edges of the sealing flaps 15, 16 extending parallel to the vertical legs 15, 16.

A further sealing flap 23, which can swivel about a horizontal axis, comprising a wear-resistant edge reinforcement 24 at the free end edge, is installed at the horizontal frame leg 18.

The sealing flaps 15, 16 and the sealing flap 23 are connected to the respective frame legs by way of articulated parts 26, which are acted upon by springs, allowing each of the sealing flaps 15, 16, 23 to be swiveled against a restoring force in the forward-push direction of the transporting and setting base 3, and in the opposite direction.

Web-type sealing elements 35 and 36 made of sheet metal protrude from the outer edges of the vertical legs 15, 16, perpendicular to the frame plane, which are subdivided into sections 37, and can be acted upon with spring forces by spring devices 25 parallel to the frame plane.

Holding rails 27 and 28 extend laterally outward from the vertical frame legs 15, 16, angled at a short distance therefrom, elongate hydraulic cylinders 29 and 30 being respectively mounted at the ends thereof facing away from the sealing frame 14. The holding rails 27, 28 extend in guides comprising rollers 31 mounted on a holding device 32 which, inter alia, accommodates the setting base 3 and can be moved on rollers 33. The holding device 32 is a component of an operating machine comprising the coking plant which not only produces the coal cake by stamping and charging the oven chambers, but also subsequently ejects the coke from the oven chambers.

Reference sign 34 indicates a further hydraulic cylinder for moving the sealing frame 14.

To load a coke cake 2 into one of the oven chambers 1 of the coking plant, the holding device 32 is moved along the coking plant until the sealing frame 14 is oriented toward the corresponding opening 5 of the relevant oven chamber 1. The door 6 of the oven chamber is removed.

The sealing frame 14 is then moved with the aid of the hydraulic cylinders 29, 30 and 34 in the direction of the opening 5 of the oven chamber 1, wherein the sealing elements 35 and 36, which protrude in a web-like manner at both sides of the sealing frame 14 from the vertical legs 15, 16 perpendicular to the frame plane, come to rest against lateral surfaces of the vertical anchor 7 facing away from the opening 5. The sealing frame 14 is then moved into the end position until the frame legs 15, 16, 18 rest against the remaining enclosure of the opening 5 and the sealing elements 35 and 36 additionally seal the sealing frame 14 at the vertical anchors 7 under the action of spring devices 25.

The transporting plate 3, having the coal cake 2 disposed freely thereon, is moved through the sealing frame 14 into the oven chamber 1. The passage cross-section remaining between the transporting plate and the free end edges of the sealing flaps 15, 16, 23 is smaller than the cross section of the coal cake 3. The coal cake 2, which is pushed forward with the transporting plate 3, thus swivels the sealing flaps 15, 16, 23 which graze the coal cake 2 while sealing the opening 5. Subdividing the vertical sealing flaps 15, 16 into flap sections 21 ensures that large gaps do not form between the sealing flaps and the coal cake, even if the side walls of the coal cake 2 are uneven.

The opening 5 is sealed by the sealing frame 14 comprising the sealing flaps 15, 16, 23, thereby ensuring that, while the coal cake 2 is being loaded into the oven chamber 1, any filling gas produced at the same time cannot be forced out of the oven chamber 1 through gaps between the opening edge and the coal cake 2. All of the filling gas reaches the adjacent oven chambers 1 by way of the transfer pipe 10, and finally reaches the crude gas line 13.

1. A device for sealing an oven chamber of a coking plant, comprising a sealing frame which can be placed against an inlet opening of the oven chamber while the oven chamber is charged with a coal cake, from which, on oppositely disposed legs, sealing flaps protrude, which can be swiveled inward by the coal cake, the free end edges of the sealing flaps grazing the coal cake.

2. The device according to claim 1, wherein the sealing flaps extend downward to a transporting plate which pushes the coal cake into the oven chamber.

3. The device according to claim 2, comprising a sealing frame which is closed and encloses the entire arrangement of coal cake and transporting plate.

4. The device according to claim 1, wherein the sealing flaps are multipart, comprising flap sections which can swivel independently of one another.

5. The device according to claim 1, comprising a further sealing flap, which can swivel about a horizontal axis, and which is provided at an upper horizontal frame leg.

6. The device according to claim 5, wherein the sealing flaps can swivel in the direction of motion of the coal cake and opposite to the direction of motion of the coal cake.

7. The device according to claim 6, wherein the sealing flaps can swivel in at least one direction against a restoring force.

8. The device according to claim 3, wherein the sealing frame is connected to horizontal rails so as to permit the sealing frame to move in a guide formed by rollers.

9. The device according to claim 3, wherein the sealing frame can be placed against anchors which are disposed on either side of the inlet opening.

10. The device according to claim 9, wherein the sealing frame comprises laterally disposed sealing elements which engage at a side of the anchors facing away from the inlet opening.

11. A coking plant comprising at least one oven chamber, and a device for sealing an inlet opening of the oven chamber while the oven chamber is charged with a coal cake.

12. An operating machine for a coke oven comprising at least one oven chamber and a device for sealing an inlet opening of the oven chamber while the oven chamber is charged with a coal cake.
